(19) United States
(12) Patent Application Publication
(10) Pub. No.: US 2024/0251458 A1
(43) Pub. Date: Jul. 25, 2024

(54) METHOD FOR ESTABLISHING A COUPLING BY RADIO LINK BETWEEN A DOMESTIC DEVICE AND AN EXTERNAL DEVICE, AND DOMESTIC DEVICE

(71) Applicant: E.G.O. Elektro-Gerätebau GmbH, Oberderdingen (DE)

(72) Inventors: Pierre Metzner, Oberderdingen (DE); Armin Riexinger, Bretten (DE); Manuel Reiser, Vaihingen Enz (DE)

(21) Appl. No.: 18/414,597

(22) Filed: Jan. 17, 2024

(30) Foreign Application Priority Data
Jan. 19, 2023 (DE) 10 2023 200 410.0

(51) Int. Cl. H04W 76/14; H04W 76/18

(52) U.S. Cl. CPC H04W 76/14; H04W 76/18

(57) ABSTRACT

In a method for establishing a coupling or radio link between a cooktop as domestic device and a mobile telephone as external device by radio link, the process proceeds via the operating means on the domestic device. During the process, an operator, by operation on a cooktop operating means, is offered a choice between different types of external device, the device types being subdivided into a plurality of groups, wherein they differ according to technical complexity and input and output possibilities. Depending on information transmitted by the external device to the radio link means, different verification routines for the radio link or coupling proceed in the device controller. A plurality of lists are stored in the device controller, in which lists coupled external devices are saved, wherein a separate list is saved for each of the groups of external devices.

### CROSS-REFERENCE TO RELATED APPLICATIONS

This application claims priority to German application Ser. No. 10/202,3200410.0, filed Jan. 19, 2023, the contents of which are hereby incorporated herein in its entirety by reference.

### FIELD OF APPLICATION AND PRIOR ART

The invention relates to a method for establishing a coupling by radio link between a domestic device and an external device separate from the domestic device, the external unit being characterized in that it does not form a structural unit with the domestic device. The external device may for example be a mobile terminal such as a smartphone or a tablet computer, or alternatively a cooking device such as a sensor saucepan or indeed an extractor apparatus or the like. The invention likewise relates to a corresponding domestic device, in particular a cooktop or an oven.

It is known from DE 19802558 A1 to control a cooktop as cooking device by remote control. The remote control may for example operate by means of an IR transmission link.

A further system is known from CN 000105830397 A1 for controlling a plurality of domestic devices using a mobile terminal. In this case, the domestic devices can be switched over on the basis of a control signal between an at-home mode and a not-at-home mode. In this way, domestic devices may for example change from a normal mode to an energy-saving mode.

It is known from DE 102014203582 A1 to monitor and optionally also run a domestic device by remote control and/or remote monitoring using a mobile terminal. This may take place via an internet server connected therebetween. The internet server may run a plurality of user accounts, such that the domestic device can be operated through access to one or another user account.

It is known from DE 102012214797 A1 to operate a domestic device using a data transmission module. This data transmission module operates with radio waves as the interface for coupling with the domestic device.

DE 102004048254 A1 discloses a method and device for detecting WLAN signals. A two-point control means with a detection device is described therein, as well as a control means for monitoring a radio signal. A radio control means may monitor a detected radio signal in terms of its current signal strength (RSSI). The result of a comparison of the data of the radio signal may be displayed with an illuminated display unit.

It is known from US 2014/0159877 A1 to configure a domestic device in such a way that it can be controlled by Bluetooth. An input means may be a smartphone as mobile terminal, wherein communication between the two proceeds via Bluetooth.

US 2002/0094778 A1 describes how, for a Bluetooth communication link, a signal strength (RSSI) can be monitored and displayed. The signal strength may thus be monitored and used to classify the radio link in terms of quality and reliability.

### OBJECT AND ACHIEVEMENT THEREOF

The object of the present invention is to provide an above-mentioned method and a domestic device configured to carry out this method, with which method and device prior art problems may be solved and it is in particular possible conveniently and reliably to carry out procedures relating to a radio link or coupling between domestic device and external device.

This object is achieved by a method having the features of claim 1 and domestic device configured to carry out this method and having the features of claim 16. Advantageous and preferred embodiments of the invention are the subject matter of further claims and are explained in greater detail below. Some of the features are described only for the method or only for the domestic device. Regardless of this, however, they are intended to apply separately and mutually independently both to the method and to the domestic device. The wording of the claims is incorporated by express reference into the content of the description.

The method involves establishing a coupling by means of radio link between a domestic device, such as an above-stated cooktop or an oven, and an external device, such as a mobile telephone, electrical device or sensor saucepan. It likewise involves the termination or discoupling of such a coupling or this coupling. The domestic device has an operating means, a device controller and a radio link means connected thereto, wherein the external device also has its own radio link means. In the invention, a radio link is established between the domestic device and the external device via the operating means on the domestic device or is started by the operator using this operating means, preferably as a function of the configuration of the operating means with differing operation using the available operating elements. This may determine the procedure, in particular as far as the accuracy of the input of information into the external device to be coupled is concerned. During establishment of the coupling or radio link by an operator by operation on the operating means and the external device, a choice is offered between different types of external device, which differ with regard to their properties. The different types of device are subdivided into groups, wherein there are several groups. One group comprises devices such as for example mobile devices such as mobile telephones, computers or notebooks or smartphones. These devices are advantageously mobile, have extensive input or operational possibilities and high computing power. Another group comprises devices such as for example electrical devices in the form of extractor hoods or extractor apparatuses and other cooking devices. These devices are advantageously not mobile, but rather are fixedly installed or fitted and have only a few operational possibilities and limited computing power. Yet another group comprises devices such as for example devices with sensors such as sensor saucepans or spits, which may have still fewer operational possibilities and still more limited computing power.

Depending on information transmitted by the external device to the radio link means, different verification routines for the radio link or coupling may or will run in the device controller. In this case, a plurality of lists are stored in the device controller, in which lists coupled external devices are saved or to which they may be saved. In this respect, a separate list is provided or created or saved for each group of external devices. Thus, the external devices may be saved in lists of separate categories or with similar external devices, which makes it possible to save them in accordance with these lists and optionally also to delete an external device again from such a list. Saving and deletion processes may thus be combined in accordance with given settings.

In a further configuration of the invention, during establishment of the coupling an operator may input on the operating means to which group of external devices the external device currently to be coupled belongs. This may preferably proceed by inputting a single number or a single symbol or letter assigned to this group on the operating means. In this way, this is easily done, while at the same time assignment to an in principle large number of groups is possible. Thus, limited input options on the operating means may also be compensated, in order nonetheless to achieve device-specific settings.

In a first configuration of the invention, an external device does not transmit any information as to the group to which it belongs. The coupled external device is in this case then saved to the corresponding group exclusively in accordance with the operator input on the operating means.

In another, second configuration of the invention, an external device transmits specific information as to the group to which it belongs. In this way, the group of the external device may be used as information in a later query once the radio link has been established. This information is here contained in a radio signal sent to the domestic device by the external device, and then this external device can accordingly be saved in the corresponding group.

In one development of the invention, coupling to the external device may proceed by inputting a code or numerical code. This may preferably apply in the event that the external device is a mobile device such as a smartphone or a tablet computer, which may thus be input on the external device. This is possible with the above-stated external devices. In this case, the code can be displayed on the operating means. It then has to be input by the operator on the external device or mobile device in order successfully to bring about pairing or coupling. The external device can then be saved in a general list or in an overall list in the device controller, wherein the radio link and the coupling with the external device is then established.

In an alternative configuration of the invention, provision may be made for the coupling to the external device to proceed without input of a code. The procedure of pairing or coupling between domestic device and external device then begins directly, which is simple, but less secure. This is advantageous precisely with above-mentioned external devices without an input option. Under certain circumstances, a certain input option may then preferably still be provided on the external device, for example also by means of just one single button or with just two buttons.

To establish a radio link, provision may be made for an operating element on the operating means to have necessarily to be operated. In particular, operation must proceed repeatedly or a code must be formed. Only once operation has proceeded as stipulated does the pairing procedure begin. In this way, an unintentional pairing procedure can be avoided.

In one development of the invention, provision may be made for the radio link to be disconnected if an external device cannot be assigned to a particular group of the groups. All the coupling data relating to this specific external device, which had already been collected, are then deleted from every device list in the domestic device, wherein the method for establishing a coupling with this external device is then terminated.

Similarly, if an external device is to be deliberately deleted, it is possible to ensure that the data from each external device, which have already been collected and saved somewhere, are deleted from every device list in the domestic device. To this end, some queries have also to be performed so as to ensure that the external device is actually deleted.

The Bluetooth standard is advantageously used for the radio link, in particular as a BLE standard. This saves energy, above all when the external device is not designed for grid operation, but rather has a secondary battery or primary batteries.

The domestic device according to the invention may be a cooktop or an oven, and is configured to carry out the above-described method. It has an operating means, a device controller and a radio link means connected thereto. Advantageously, the operating means has operating elements, particularly advantageously also a display unit. This may be a seven-segment display unit with one or more display units, or alternatively a screen such as a display or even a touch display. A memory with the stated lists therein is also provided in the device controller.

These and further features are revealed in the description and in the drawings as well as in the claims, wherein the individual features can each be realized singly or severally in the form of sub-combinations in one embodiment of the invention and in other fields, and can represent embodiments advantageous and protectable per se, for which protection is claimed here. Subdivision of the application into individual sections and intermediate headings does not limit the general applicability of the statements made thereunder.

### BRIEF DESCRIPTION OF THE DRAWINGS

Exemplary embodiments of the invention are shown schematically in the drawings and are explained in more detail below. In the drawings:

FIG. 1 is a schematic representation of a cooktop as domestic device with a mobile telephone and an extractor hood as external devices,

FIG. 2 is a representation of a sequence resulting in coupling and optionally pairing of an external device to a domestic device, and

FIG. 3 is a representation of discoupling of the coupling and pairing of FIG. 2 including deletion from lists.

### DETAILED DESCRIPTION OF THE EXEMPLARY EMBODIMENTS

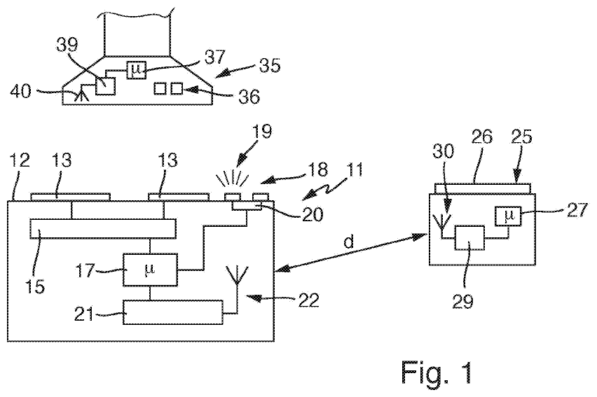

FIG. 1 is a highly schematic representation of a cooktop 11 according to the invention as domestic device according to the invention. The device has on the top or cooktop plate 12 a plurality of heating means 13, which may be driven or supplied with power by a power control 15 in the cooktop and thus operated. The power control 15 is connected with a controller 17 as device controller of the cooktop 11. The controller 17 may be a central controller for the entire cooktop 11 and for example drive an operating element 18 of an operating means 20 and a visual display unit 19 at the top on the cooktop 11. It goes without saying that, as is conventional with modern cooking devices or cooktops, considerably more operating elements and visual display units of modern design may also be provided. In a simple configuration, a visual display unit may take the form of an illuminated display unit, for example in the form of an LED, or a display, for example also a touch display, i.e. with the integrated function of operating elements.

The controller 17 is coupled with a radio link means 21 including antenna 22, which operates with the Bluetooth standard, advantageously according to the BLE standard, i.e. with low energy usage. This is practical. Alternatively, it could operate using the Zigbee standard or another similar radio protocol.

Furthermore, FIG. 1 shows a mobile telephone 25 as mobile external device according to the invention. The mobile telephone 25 takes the form of a smartphone with touch screen 26 and contains, in addition to a conventional controller 27 or a processor, its own radio link means 29 including antenna 30, which is also configured according to the Bluetooth standard or advantageously according to the BLE standard.

In the representation shown here, the mobile telephone 25 is situated within a distance d of the cooktop 11 or specifically the antennas 22 and 30 are at this distance from one another. Due to the known limited device dimensions of cooktop 11 and mobile telephone 25, however, this is of no importance. In any case, reception is good.

Furthermore, an extractor hood 35 is shown as a further external device above the cooktop 11. This serves, as is known, to capture steam and odors from a cooking process on the cooktop 11 or to clean the air in known manner. The extractor hood 35 has a plurality of operating buttons 36, advantageously, in accordance with the prior art, for lighting and adjusting fan power. Moreover, a controller 37 is provided which has its own radio link means 39 including antenna 40. A Bluetooth or even a BLE standard is advantageously also provided here. Mobile telephone 25 and/or extractor hood 35 should thus be able to couple by Bluetooth or BLE to the cooktop 11. In the case of the mobile telephone 25, this provides the possibility of being able to display information on the mobile telephone 25 or to control the cooktop 11 with the mobile telephone 25. This may proceed either after manual setting or by means of programs running on the mobile telephone 25. It is necessary to take into consideration the fact that, under real-world conditions, the mobile telephone 25 may be or has frequently to be coupled with the cooktop 11, since it is frequently removed therefrom, thus discoupling a link. In principle, however, the mobile telephone 25 is known in the controller 17, which in each case simplifies coupling. For this, re-identification does not have to proceed every time like the first time.

In the case of the extractor hood 35, on the other hand, provision is made for both devices to be fixedly installed or fitted and thus to be in a fixed relationship with one another which does not change. A radio link is possibly interrupted when at least one of the two devices is switched off. It has however to be assumed, with each switch-on, that there is and indeed should be at least the possibility of automatic re-establishment of the radio link.

Further possible external devices apart from mobile telephones and extractor hoods may be the above-stated devices with sensors, for example sensor saucepans, which are heated in known manner on one of the heating means 13 of the cooktop plate 12 of the cooktop 11. If an oven is used as the domestic device instead of the cooktop 11, the above-mentioned spits with temperature sensors and radio link could be used.

It is known from the prior art that, in the case of pairing, the Bluetooth standard and thus also the BLE standard save the coupled devices in a list of known devices. Conventionally, devices provided with Bluetooth have a maximum number of devices that may be coupled thereto, since the lists may be only of limited size. In this case, these devices are entered in the lists. If a list is full, then only once the complete list has been deleted or individual devices have been removed from this list can new devices be linked or coupled thereto. The above-mentioned devices such as extractor hoods or the like, which are also fixedly installed or fitted, and sensor saucepans or spits with temperature sensors are replaced less often than mobile devices such as for example mobile telephones. For this reason, these should be deletable from a list of known devices separately from the mobile devices. In the case of mobile devices with which operation of the domestic device may also proceed, range monitoring may additionally be necessary. This is not relevant to the present invention, however.

The invention makes it possible to distinguish between different device types or types of external devices and to manage them differently. Both saving and deletion of specific device types or specific devices is possible. Furthermore, various functionalities may be supported according to device type or device type groups. It is possible, for example, to store additional information in device-specific lists which allows devices or external devices to be deleted which are rarely or never used. Furthermore, range monitoring may be enabled for mobile devices that are distinguished by high mobility and thus also frequent moving too far away from the domestic device.

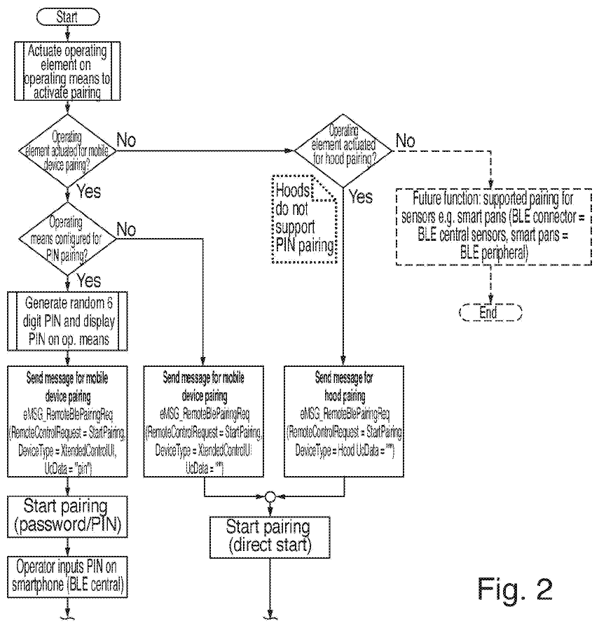

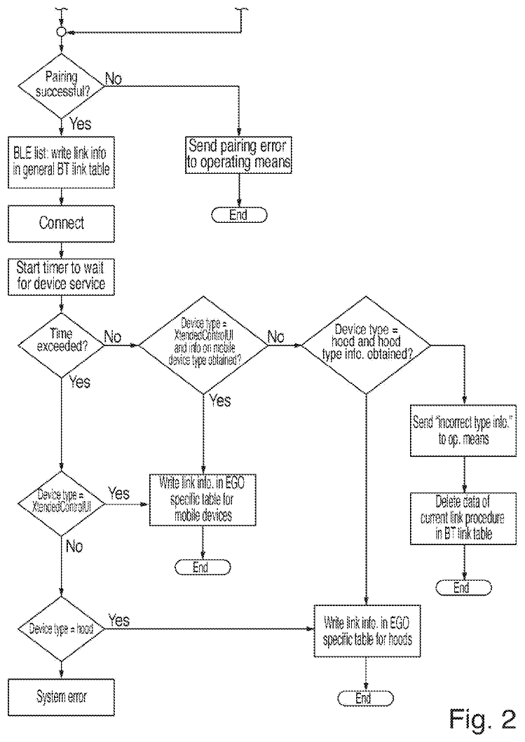

It is clear from FIG. 2 how coupling and optionally pairing of an external device to a domestic device, for example the cooktop 11 according to FIG. 1, may proceed. To begin with, an operator actuates an operating element 18 on the operating means 20 of the cooktop 11, in order to activate coupling or pairing. Depending on the device type or group of device types to which the external device to be coupled belongs, according to a first option different operating elements 18 on the operating means 20 may be actuated. According to a second option, it may always be the same operating element, and for example by repeated actuation, the correct group can be selected in accordance with a display option on the display unit 19. If it is then either specified on the operating means 20 by operator input that a mobile device of the corresponding group is to be coupled, or the external device issues a query thereto, it may be checked on the operating means 20 whether a coupling is possible there using as code a PIN advantageously consisting solely of numbers. If the coupling is not possible, a message for the coupling of mobile devices may be sent. This may be received on the external device. If coupling by PIN as code is possible, then a four-digit or six-digit PIN may for example be generated by the controller 17 and displayed on the visual display unit 19 as corresponding screen. A message is then likewise sent, so that the mobile device can be coupled. The coupling method may then begin or pairing proceed, for which purpose an operator has to input the above-stated six-digit PIN into the mobile device, for example a smartphone. Alternatively, if no PIN can or is to be used, the pairing or coupling procedure may start directly.

If an operator input on the operating means 20 does not select that a mobile device type such as smartphones is to be coupled, the next step is to check whether a group of fixedly installed or fitted electrical devices such as for example extractor hoods is to be coupled. If this is the case, the radio link means 21 sends a message to couple extractor hoods. As before, pairing then begins without input of a PIN or the like, which, as is apparent, would be difficult or impossible with an extractor hood.

If no input proceeds at the operating means 20 that an assigned separate electrical device such as for example an extractor hood is to be coupled, in a further development a mobile external device with sensors, such as a sensor saucepan or spit with temperature sensor could be coupled. With this group of external devices, the procedure would proceed in fundamentally the same way as with the extractor hood. A display unit or a plurality of operating elements are not to be expected here either.

In this case, therefore, the operator can determine on the operating means 20 the group of device types to which the external device to be coupled or linked belongs. Furthermore, which specific device type the external device to be coupled is may be temporarily stored for a later query.

If, according to the remainder of the procedure, no successful coupling or successful pairing has been possible, a corresponding error message is then sent to the operating means 20 and the controller 17 of the cooktop 11. Thus at least the operating means 20 knows that coupling or pairing was unsuccessful. If coupling is successful, however, the corresponding information is entered in a general BT link table. Furthermore, the information for coupling may be saved in a general BT coupling table in which other devices which are to be coupled to the cooktop 11 or have already been coupled thereto once may also be saved.

In the BT list, information about the link is entered into a general BT link table. coupling then proceeds, whereupon a timer is started to wait for device service or for whether information comes back from the external device. If no corresponding reply comes from the external device within a specific time, for example a few seconds, it may be determined that no particularly complex external device is to be coupled. It thus cannot itself transmit its device type or the group of devices to which it belongs. Standard control is thus assumed, since the operator has input this at the start, for example as for the extractor hood 35. The corresponding group of devices is accordingly then determined. This group of devices may be characterized in that they are stationarily installed and constantly coupled to the cooktop 11.

Once a given time has been exceeded after the query, the information may also be detected that the external device to be coupled can sent a reply or information about its own device type to the controller 17. It may thus, for example, be a mobile device, and the information about the coupling is then entered in a very specific list for this group of devices which the manufacturer of the cooktop 11 has programmed into the controller 17. Thereafter, the linking or coupling process terminates for the corresponding mobile device.

If, however, the external device is for example an extractor hood, the corresponding information about the extractor hood may likewise be entered into the above-stated manufacturer-specific list for external devices, such as for example extractor hoods. This is also a manufacturer-specific list. Since however, according to the above explanation, the extractor hood 35 differs from the mobile telephone 25 with regard to certain characteristics, it is preferably, as described above, entered in its own specific list.

If no extractor hood can be ascertained as external device on the basis of the reply from the external device, the message is returned to the controller 17 that incorrect information has been returned here which does not match the input for the external device to be coupled. The coupling data of the current linking process are thus deleted in the BT link table and the process is terminated. The group to which the external device to be coupled belongs could ultimately not be unambiguously determined.

Since mobile devices are more frequently replaced, for example every two years with conventional contract renewal, it must also to be possible to delete them more frequently from the lists. The lists would otherwise become too long or fill up too quickly. In the case of an extractor hood, this problem will very probably not arise.

The way the process proceeds from when the timer is started is optional, and these option can thus also be omitted. An option may thereafter also be offered where the external device to be coupled identifies itself. However, here too a given preselection by an operator at the cooktop 11 is advantageous.

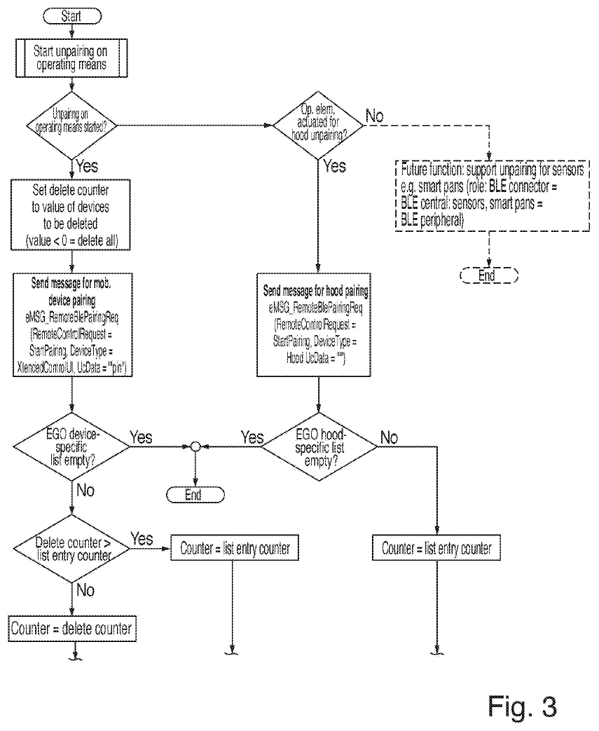

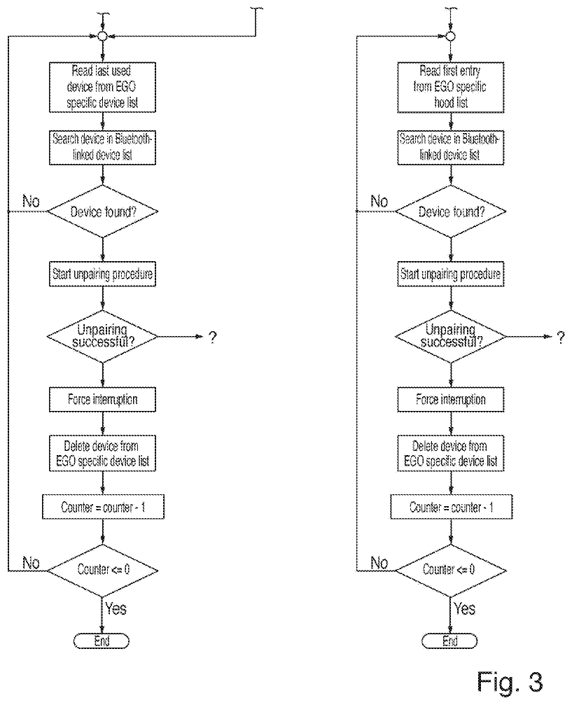

Hereinafter it will be explained with reference to FIG. 3 how a radio link or coupling can be discoupled such that an entry is deleted from one of the lists. This serves to ensure that the lists do not become too full, in particular in order to ensure no error or abort arises on coupling of a new apparatus as in FIG. 2 if the list is, as it were, already full.

Once the process has begun, a corresponding unpairing process is started at the operating means 20 of the cooktop 11. This may proceed for a mobile telephone 25 or for an extractor hood 35 or for another external device. A different operating element 18 of the operating means 20 may in each case be provided for this purpose. If a mobile telephone 25 is to be deleted from a list, and the corresponding operating element 18 is actuated, a counter is set to the number of devices to be deleted. Then a message is sent to a mobile device and at the same time it is queried whether the device-specific list from the manufacturer of the cooktop 11 is empty. In the event that it is empty, the method can be terminated, since nothing can or has to be deleted. If the list is not as yet empty, it is checked whether the number of devices to be deleted is greater than the number saved in the list. If this is the case, the number is set to the number of entries in the list. If this is not the case, the number is set to the number of devices to be deleted. Then the last used device is selected from the device-specific list and at the same time searched for in the BT link list. If the device is not found, the process is restarted from the top. If it is found in the BT link list, the process of unpairing begins. If unpairing is not successful, the process must continue differently, for example be restarted from the top. Otherwise, interruption of the coupling is forced and the device deleted from the device-specific list. The counter is then reduced by one and, providing the counter is not less than or equal to zero, the process is restarted from the top. If, on the other hand, the counter is less than or equal to zero, the list is empty and the process is terminated.

Unpairing of the extractor hood 35 proceeds in similarly to unpairing of the mobile device, for example. If the corresponding operating element 18 has been actuated, a message is dispatched relating to the extractor hood 35 and it is checked whether or not the relevant manufacturer-specific list is empty. If it is empty, nothing can or has to be deleted and the process is terminated. If it is not empty, the process continues and accordingly proceeds as previously described for the mobile telephone 25.

It is thus also clear from FIGS. 2 and 3 how corresponding entries may be set or deleted from specific manufacturer-specific lists for external devices, such as for example from a group of mobile devices on the one hand or fixedly installed electrical devices on the other hand. The method according to the invention is intended to make it simple, convenient and reliable for an operator to achieve this even if external devices, such as for example extractor hoods, have distinctly fewer operating options or no PIN inputs are possible in the case of cooktops with limited operating options.

1. A method for establishing a coupling using radio link between a domestic device, such as a cooktop or an oven, and an external device, such as a mobile telephone, electrical device or sensor saucepan, wherein said domestic device has an operating means, a device controller and a radio link means connected therewith, wherein said external device has its own radio link means, wherein:
establishment of a radio link between said domestic device and said external device proceeds via said operating means on said domestic device,
during establishment of said coupling or said radio link by an operator by operation on said operating means and said external device, a choice is offered between different types of external devices, wherein said different device types are subdivided into groups,
said device types having a plurality of groups in each case comprising:
mobile devices such as mobile telephones, computers or smartphones,
electrical devices such as extractor hoods or extractor apparatuses and other cooking devices,
devices with sensors, such as sensor saucepans or spits,
depending on information transmitted by said external device to said radio link means, different verification routines for said radio link or said coupling are run in said device controller,
a plurality of lists are stored in said device controller, in which lists coupled external devices are saved, wherein a separate list is saved for each of said groups of external devices.

2. The method as claimed in claim 1, wherein, during establishment of said coupling, an operator inputs on said operating means said group of external devices to which said external device currently to be coupled belongs.

3. The method as claimed in claim 2, wherein, during establishment of said coupling, an operator inputs on said operating means a single number or a single symbol or a single letter which are assigned to this group, in order to input said group of external devices to which said external device currently to be coupled belongs.

4. The method as claimed in claim 1, wherein an external device does not transmit any information as to said group to which it belongs, wherein said coupled external device is saved to said corresponding group exclusively in accordance with said operator input at said operating means.

5. The method as claimed in claim 1, wherein said group of said external device is used as information in a later query once said radio link has been established, wherein this information is contained in a radio signal sent to said domestic device by said external device, and then this external device can accordingly be saved in said corresponding group.

6. The method as claimed in claim 1, wherein said coupling to said external device proceeds by inputting a code, wherein said code is displayed on said operating means and has to be input by said operator on said external device or mobile device in order successfully to bring about pairing or coupling.

7. The method as claimed in claim 1, wherein said coupling to said external device proceeds by inputting a code in the event that said external device is a mobile device such as a smartphone or a tablet computer.

8. The method as claimed in claim 6, wherein said external device is then saved in a general or overall list in said device controller, wherein said radio link and said coupling to said external device is subsequently established.

9. The method as claimed in claim 1, wherein said coupling to said external device proceeds without input of a code and said pairing or coupling procedure begins directly.

10. The method as claimed in claim 1, wherein, to establish a radio link, an operating element on said operating means has to be operated and only after successful operation does said pairing process begin.

11. The method as claimed in claim 10, wherein, to establish a radio link, an operating element on said operating means has to be operated repeatedly or has to be operated to form a code.

12. The method as claimed in claim 1, wherein said radio link is discoupled if an external device cannot be assigned to a particular group of said groups and all coupling data relating to this external device are deleted from every device list, wherein said method for establishing a coupling is then terminated.

13. The method as claimed in claim 1, wherein, if an external device is to be deliberately deleted, said data from each external device, which have been saved, are deleted from every device list in said domestic device.

14. The method as claimed in claim 1, wherein the Bluetooth standard is used for said radio link.

15. The method as claimed in claim 14, wherein the BLE standard is used for said radio link.

16. A domestic device, which is configured to carry out said method as claimed in claim 1 and which has an operating means, a device controller and a radio link means connected thereto.

17. The domestic device as claimed in claim 16, wherein said domestic device is a cooktop or an oven.
